(19) United States
(12) Patent Application Publication
(10) Pub. No.: US 2013/0100986 A1
(43) Pub. Date: Apr. 25, 2013

(54) METHOD OF ADAPTING A WIRELESS SYSTEM FOR USE IN A GEOGRAPHIC LOCATION

(71) Applicants: Adam M. GETTINGS, Palo Alto, CA (US); Andrew G. STEVENS, Palo Alto, CA (US)

(72) Inventors: Adam M. GETTINGS, Palo Alto, CA (US); Andrew G. STEVENS, Palo Alto, CA (US)

(73) Assignee: RoboteX, Inc., Palo Alto, CA (US)

(21) Appl. No.: 13/597,213

(22) Filed: Aug. 28, 2012

Related U.S. Application Data
(60) Provisional application No. 61/550,731, filed on Oct. 24, 2011.

(51) Int. Cl. H04W 72/04; H04B 1/713

(52) U.S. Cl. 375/132; 455/509; 375/E01.033; 901/2; 901/1

(57) ABSTRACT

A wireless communication system comprises a first computing device and a second computing device, wherein the first computing device and the second computing device communicate over a wireless channel that is selected based in part on a geographic location of at least one of the first computing device and the second computing device. The wireless channel that is selected provides long range communications, on the order of 60 miles and more. The computing devices may be a robot controller and a controlled robot, or they may be wireless router and a computing device configured with a wireless transceiver.

### CROSS-REFERENCE TO RELATED APPLICATIONS

This application claims the benefit of U.S. provisional patent application entitled “Method of Adapting a Wireless System for Use in a Geographic Location,” filed on Oct. 24, 2011, and having application Ser. No. 61/550,731, which is incorporated herein by reference.

### BACKGROUND

This disclosure relates in general to wireless communication systems and methods, and more specifically to a new and useful system and method for selectively changing wireless communication channels based on geographic location.

In September 2010, the FCC decided that unused television channels (channels 2-51) between TV stations can be used for mobile broadband applications. Details of the decision are available in FCC 10-174 ET Docket No. 04-18, available at http://transition.fcc.gov/Daily_Releases/Daily_Business/2010/db0924/FCC-10-174A1.pdf.

### SUMMARY

Embodiments disclosed herein employ unused television channels between 54 and 698 MHz, known as “white space channels,” in new and useful ways.

In one embodiment, a robotic system includes a robot and a robot controller, at least one of which detects its geographic location. A wireless channel that is available at the detected location, and which may include one of the white space channels, is selected, and the robot and the robot controller then communicate over the selected wireless channel. If either the robot or the robot controller moves to a new location, the new location is detected and a new available wireless channel is selected, if necessary.

In another embodiment, a first computing device communicates with a second computing device through one or more intermediate transceivers. The first device communicates with one of the intermediate transceivers over a first wireless channel (which may be white space channel) determined based on the geographic location of the first device and the intermediate transceiver. The second device communicates with one of the intermediate transceivers over a second wireless channel (which may be a white space channel) determined based on the geographic location of the second device and the intermediate transceiver, where the second wireless channel is different than the first wireless channel. The intermediate transceiver in communication with the first device and the intermediate transceiver in communication with the second device may be the same transceiver or different transceivers.

A method according to an embodiment comprises determining a geographic location of a controlling device and determining wireless channels that are available at the geographic location. The method further comprises selecting an available wireless channel based in part on the geographical location of the controlling device, and communicating over the selected wireless channel with a controlled device.

A method according to another embodiment comprises determining a geographic location of a controlled device and transmitting the geographic location of the controlled device to a controlling device over a first wireless channel. The method further comprises receiving a transmission from the controlling device indicating a frequency of a second wireless channel, and communicating with the controlling device over the second wireless channel.

Numerous technical advantages are provided according to various embodiments of the present disclosure. Particular embodiments of the disclosure may exhibit none, some, or all of the following advantages depending on the implementation.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

So that the manner in which the above recited features of the present disclosure can be understood in detail, a more particular description of the present disclosure, briefly summarized above, may be had by reference to embodiments, some of which are illustrated in the appended drawings. It is to be noted, however, that the appended drawings illustrate only typical embodiments of the present disclosure and are therefore not to be considered limiting of its scope, for the present disclosure may admit to other equally effective embodiments.

FIG. 1 illustrates an example robotic system that utilizes white space channels for communication.

FIG. 2 illustrates a controller according to one embodiment.

FIG. 3 illustrates a robotic device according to one embodiment.

FIG. 4 illustrates a map of available television white space channels by United States county.

FIG. 5 illustrates one example embodiment of a table of available wireless channels for a number of geographic locations

FIG. 6 illustrates an example system for transmitting data over available white space channels.

FIG. 7 illustrates an example mesh network system for transmitting data over available white space channels.

FIG. 8 is a flowchart describing one example method of adapting a wireless system for use in a specific geographic location.

FIG. 9 is a flowchart describing another example method of adapting a wireless system for use in a specific geographic location.

### DETAILED DESCRIPTION

In the following description, numerous specific details are set forth to provide a more thorough understanding of embodiments of the disclosure. However, it will be apparent to one of skill in the art that embodiments may be practiced without one or more of these specific details. In other instances, well-known features have not been described in order to avoid obscuring embodiments of the present disclosure.

A geo-adaptive wireless system can be used to enable wireless communications between computing devices, such as mobile phones or links between a robot controller and a robotic system, within the spectrum allocation of local jurisdictions. As an example, local jurisdictions may have specific rules that detail which frequencies may be used for wireless communications. Currently, the industrial, scientific, and medical (ISM) frequency bands may be used in most jurisdictions (these jurisdictions may include United States counties or states, countries of the world, international waters, property lines, borders, or other jurisdictions). In some jurisdictions, television white space channels also may be used. White space channels are unused broadcast television channels between 54 and 698 MHz. They employ lower frequency radio waves, which tend to propagate better through walls in buildings and can provide a longer range (generally about 60 miles or more, but varies depending on the antennas used) for wireless communications. In general, a communication system that utilizes white space channels defined by local jurisdictions can benefit from improved range, improved propagation, and possibly improved data rates.

Additionally, a geo-adaptive wireless system can be used to bridge communications across an area where a specific frequency channel is in use, effectively creating a larger “mesh” network by transmitting/receiving data over available white space channels to/from relay nodes. Additional communication channels, for example a channel in the Industrial Scientific Medical (ISM) band, or a GSM/CDMA device could be used to bridge connections where there are no free whitespace Wi-Fi channels, or there is too much interference on the free whitespace Wi-Fi channels. Furthermore, more data can be sent over ISM/GSM/CMDA channels if two transceivers are within range, and higher data rates can allow bursts of data, for example, to copy a large amount of image or video data from a robotic system to a controller. Such a system could be used for emergency communications in large metropolitan areas or in areas with heavy infrastructure and/or complex FCC spectrum regulations. In particular, during an attack on communication infrastructure, a backup network could operate across a city or even a country without compromising existing communication channels (e.g., TV, Radio, cell phones, 3G and 4G data, Wi-Fi, police and safety frequencies, satellite communication) that may or may not have survived an attack. In one variation, the geo-adaptive wireless system can take over compromised or uncompromised communication channels and repurpose them for emergency communication, such as using public access or publicly supported television channels for wireless communication during a crisis.

In the U.S., white space channels are made available based on geographic location. For example, a channel available for communication in one county may not be available in an adjacent county. A system using a TV white space channel needs to know which channels are available at its current location or locations. In addition, if one or more of the communication devices in the system moves to a new jurisdiction, the devices need to determine the available channels in the new jurisdiction and switch to an available channel, if appropriate.

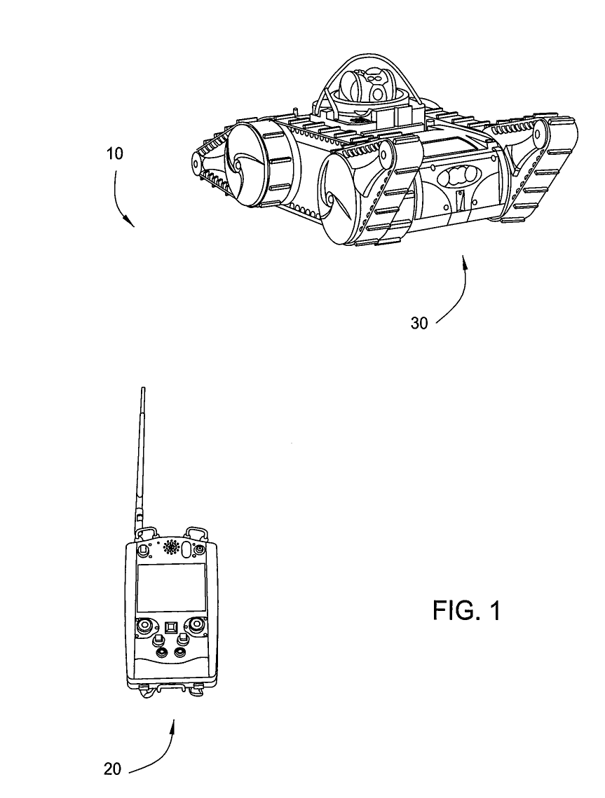

FIG. 1 illustrates an example robotic system that utilizes white space channels for communication. System 10 comprises a controller 20 (a controlling device) and a robotic system 30 (a controlled device). Controller 20 may comprise any type of controller for communicating wirelessly with robotic system 30. Controller 20 and robotic system 30 communicate wirelessly with one another over a wireless channel. In certain embodiments, they may communicate with one another over a wireless channel that is in ISM frequency bands in order to remain compliant in many jurisdictions. In other embodiments, they may communicate with one another over a wireless channel that is a white space channel. For example, if controller 20 and robotic system 30 are in a jurisdiction (geographical location) where one or more white space channels are available, they may select one of them for communication with one another so that wireless communication with longer range and better propagation through barriers can be achieved relative to other wireless channels. As an example, wireless signals in the 2.4 GHz ISM band, such as 802.11b Wi-Fi signals, may have an outdoor range of about 100 meters. White space frequencies between 54 and 698 MHz spread widely and can penetrate obstacles, which allows for ranges of 60 miles or more. In accordance with one embodiment of the present disclosure, controller 20 and/or robotic system 30 are operable to determine their location and use that location information to find and select an available white space channel. A Global Position System (GPS) may be used to determine location, or in some embodiments other methods may be used, such as cellular networks. Controller 20 and robotic system 30 may be mobile devices, so in some embodiments they may periodically check their location to determine if they have moved to a new jurisdiction that requires using a different white space channel in order to be in compliance with local regulations. Controller 20 or robotic system 30 may also check their location on demand from a user and adjust their communication frequency if necessary. Controller 20 and/or robotic system 30 may comprise a programmed processor used to select an available white space channel, or may use any other appropriate hardware or software to select a channel.

As one example embodiment, a law enforcement officer may use controller 20 to control a robotic device 30 in an outdoor environment. This operation may require robotic device 30 to be deployed and used over a large geographical area, such as in connection with a search and rescue. When system 10 is deployed, controller 20 may determine its geographical location via GPS and select an available white space channel for communication. This channel can be communicated to robotic device 30 and communication can begin over the white space channel. During the operation, controller 20 and robotic device 30 may end up a long distance away from one another. Periodically or on demand, robotic device 30 may determine its geographical location and communicate that information to controller 20. Controller 20 can then use that location information to determine if robotic device 30 has entered a new jurisdiction with different restrictions on white space channels. If robotic device 30 has entered a new jurisdiction, the current white space channel being used may not be available for use in that new jurisdiction. If this is the case, controller 20 and robotic device 30 will need to select a different white space channel for communication. Controller 20 can access a list or database of available channels for the new jurisdiction in a variety of ways described below, and then select a new channel. The new channel information can be sent to robotic device 30 and communication between controller 20 and robotic device 30 can then begin over the newly selected channel. If controller 20 and robotic device 30 are located in different jurisdictions, the selected channel would be available in both jurisdictions. In some example embodiments, multiple controllers or multiple robotic devices may be utilized, and it may be necessary to find a common channel among three or more devices that are located within three or more jurisdictions. In situations where it might not be possible to find a common channel, multiple channels may be used to enable wireless communication between the devices of the system.

Controller 20 and/or robotic device 30 may find and select available channels in a variety of ways. As one example, either controller 20 and/or robotic device 30 may include a memory that stores a look-up table containing available channels and jurisdictions where they are available. The memory can be accessed at any time to determine an available channel based on the location of one or more of the components of system 10. In another example embodiment, either controller 20 and/or robotic device 30 may query a database, server, or website that maintains a listing of the available wireless channels in different jurisdictions, such as the website of Spectrum Bridge, Inc. (http://whitespaces.spectrumbridge.com/whitespaces/home.aspx) for at least one available channel over a data connection that can be used at the current location(s). A wireless channel then can be selected from any of the available wireless channels. In yet another example, a mapping software algorithm may be used that compares the GPS location(s) of controller 20 and/or robotic device 30 to regions outlined on a map and associates the location(s) with one or more available wireless channels.

In yet another example embodiment, a user of system 10 may select a channel from a displayed listing of available wireless channels. If multiple controller/robotic device systems are being used in the same geographic location, it may be advantageous for the systems to each use a unique channel selected from a group of available wireless channels so as to minimize interference. Interference can be measured as a signal to noise ratio (SNR) or as statistical channel outage time or channel outage time artifacts (i.e. a transceiver is using the channel periodically or non-periodically, causing measurable periodic or non-periodic interference and channel downtime). Two or more users can each obtain a list of the available wireless channels and manually select their channels to avoid using the same channel.

Some embodiments of system 10 may include a frequency hopping algorithm to hop between available frequency channels. A controller 20 and a robotic device 30 can switch among available channels during wireless communication. A pseudorandom sequence can be used that is known by both controller 20 and robotic device 30. Frequency hopping allows for more efficient use of bandwidth and also makes wireless communications more difficult to intercept.

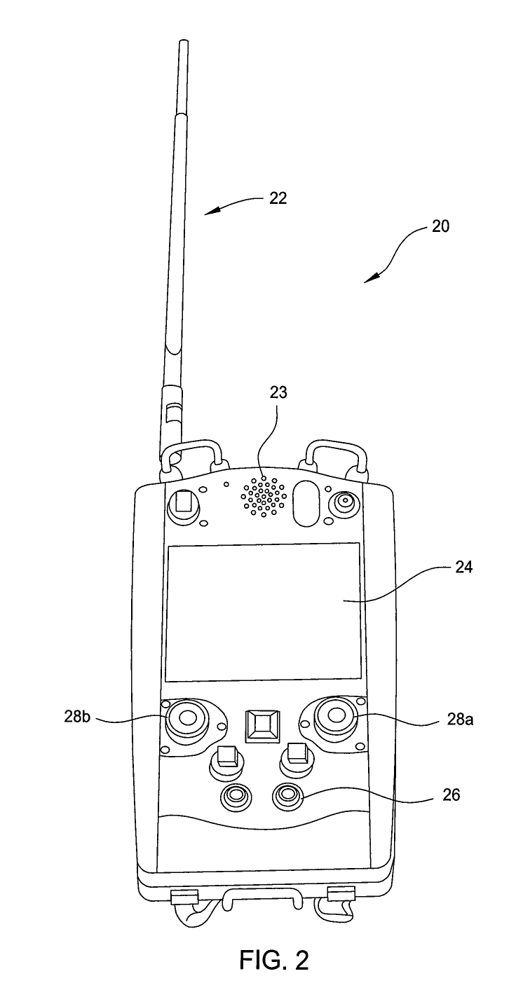

FIG. 2 illustrates a controller 20 for use in system 10. Controller 20 comprises any type of device operable to wirelessly communicate with a controlled device. In one example embodiment, controller 20 comprises a controller for a RoboteX Avatar® II robot. Controller 20 includes an antenna 22 for wireless communication that is operable to send and receive data over white space channel frequencies, such as frequencies between 54 and 698 MHz. In some embodiments, controller 20 may have two or more antennas 22, and the antennas 22 may be external or internal antennas. Controller 20 also includes a display 24. Display 24 may be any type of display, including a touch-screen display. Display 24 may also support split screen viewing of multiple camera systems, which would allow for a single controller 20 to control more than one controlled device simultaneously. As shown, controller 20 includes a number of buttons 26 used to perform various operations and operate various features on the controlled device, one or more joysticks 28, such as joysticks 28a and 28b, for controlling movement of the controlled device or for controlling accessories associated with the controlled device, such as cameras or manipulator arms, and a two-way speaker/microphone 23 for communicating remotely with people, animals, objects, etc., at or near the controlled device.

Controller 20 also includes a number of internal components (not shown) for providing functionality in system 10, such as one or more computer processing chips operable to perform functions associated with system 10, one or more memory modules for storing data, a GPS or other location detecting device, and hardware for accessing cellular networks for sending and/or receiving voice or data. Controller 20 further includes any number of audio or video components for sending, receiving, displaying, outputting, or processing audio or video data, and hardware and/or software operable to select an available wireless channel for communication and to communicate over that wireless channel.

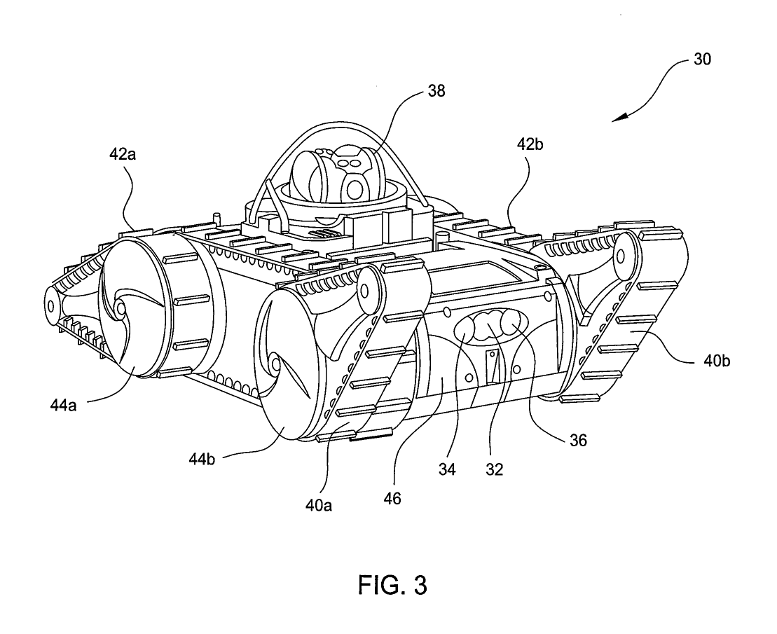

FIG. 3 illustrates a robotic device 30 for use in system 10, which is controlled wirelessly by controller 20. In this example, robotic device 30 comprises a RoboteX Avatar® II robot. Robotic device 30 comprises a front-mounted drive camera 32, an IR light 34, a headlight 36, and a 360-degree camera 38 for capturing video. Robotic device 30 also comprises various mechanical elements, such as front articulated flippers 40a and 40b for climbing, self-righting, and navigating over obstacles, and tracks 42a and 42b that are powered by drivetrain motors 44a and 44b, respectively. In addition, robotic device 30 comprises audio speakers 46.

Robotic device 30 includes other external components or internal components (not shown) for performing various operations in system 10, such as one or more antennas for communicating with controller 20 and/or for communicating with other devices or systems, (e.g., a cellular network), a GPS or other location detection module, a number of computer processing chips to perform functions, such as navigation, movement, or controlling accessories, and one or more memory modules for storing data. Robotic device 30 further includes any number of audio or video components for sending, receiving, displaying, outputting, or processing audio or video data, and hardware and/or software operable to send and/or receive data over an available wireless channel.

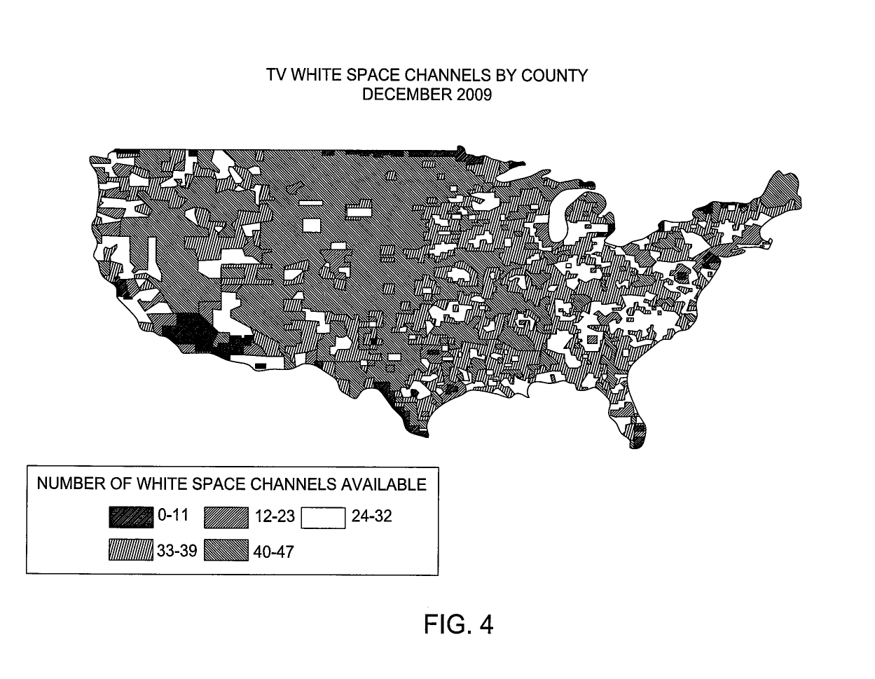

FIG. 4 illustrates a map of available television white space channels by United States county. In FIG. 4, different shades are used to represent the number of white space channels available in each county. Some counties do not have any white space channels available, while others have more than forty. A digitized version of the map such as this could be used as part of a system for selecting an available white space channel based on geographic location.

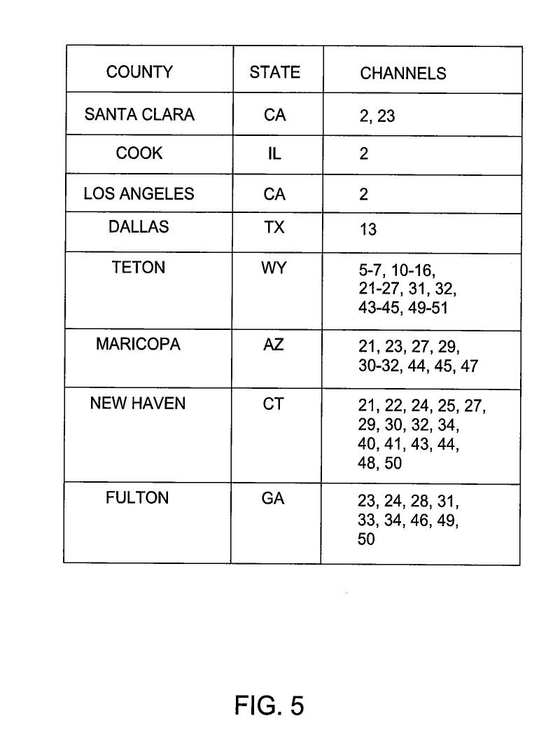

FIG. 5 illustrates one example embodiment of a table of available wireless channels for a number of geographic locations. The table lists a U.S. county, state, and the available channels in that county. The available channels shown are only examples and may not reflect the actual channels available in those locations. A table such as this could be used by system 10 to select a channel based on a geographic location. The table may include any number of locations, or may include any other jurisdictions instead of or in addition to counties. For example, another table could include available channels organized by GPS coordinates, in which case a controller 20 or robotic device 30 can use its location information and a table such as this to determine the available white space channels in that location, and then select an available channel. A table of available channels may be stored locally on one of the components of system 10 or could be stored on a server accessible by one or more of the components via a data connection.

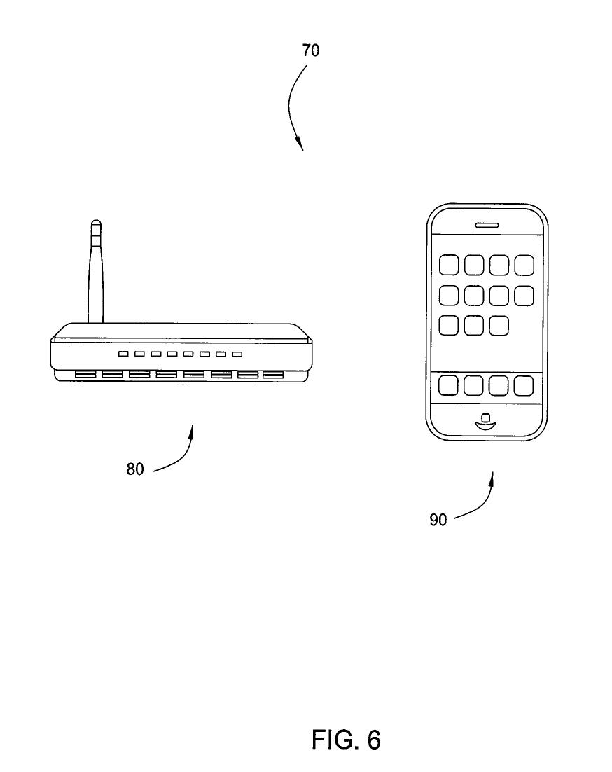

FIG. 6 illustrates an example system 70 for transmitting data over available white space channels. System 70 comprises a wireless router 80 and a computing device 90. In other embodiments, system 70 could comprise multiple routers 80 and/or multiple computing devices 90. Wireless router 80 comprises any device operable to communicate wirelessly with another device. Wireless router 80 could be a stationary device or a mobile device. One or more components of system 70 may comprise a means for detecting its location, such as a GPS sensor. The location of one or more of the components may be used to select an available white space channel for communication.

In one example embodiment, computing device 90 is a mobile device, such as a laptop computer, a tablet computer, a smartphone, or the like, that communicates with wireless router 80 over a wireless channel. In one embodiment, computing device 90 may detect its location with a GPS sensor and send that location information to wireless router 80. Wireless router 80 can then use the location information to select an available white space channel for communicating with computing device 90. Wireless router 80 may query a database or website and receive a listing of at least one white space channel that can be used to communicate at the current location. Wireless router 80 can transmit the channel information to computing device 90, and communication over the white space channel can begin. Wireless router could also detect its location with a GPS sensor or other location detection device and use that location information to select an available white space channel. For example, if wireless router 80 and computing device 90 are in separate jurisdictions, available white space channels can be queried for each jurisdiction and a channel can be selected that is available in both jurisdictions.

Wireless router 80 may be in communication with two or more computing devices simultaneously over different white space channels. In such an embodiment, two or more white space channels may be available in the jurisdiction where wireless router 80 is located. Wireless router 80 may communicate with one or more computing devices over a first channel, and communicate with one or more other computing devices over a second channel. In another example, wireless router 80 may be communicating with a first computing device located in a first jurisdiction and a second computing device located in a second jurisdiction. Different white space channels may be available in these different jurisdictions, so wireless router 80 may communicate over a first white space channel with the first computing device and over a second white space channel with the second computing device. If one or more of the computing devices moves to a new jurisdiction and sends new location information to wireless router 80, wireless router 80 may use the new location information to select a different white space channel, if the current channel is not available in the new jurisdiction.

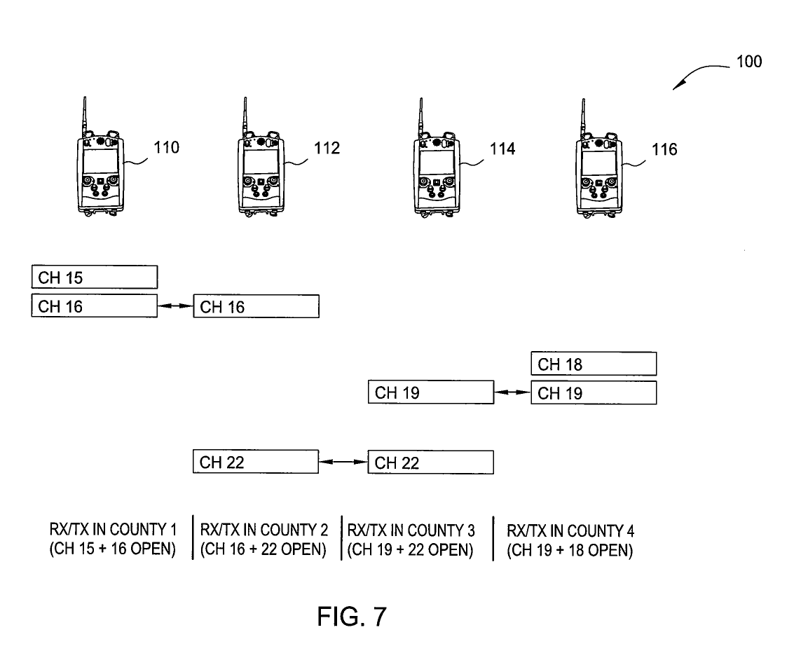

FIG. 7 illustrates an example mesh network 100 having a plurality of nodes for transmitting data over available white space channels. Computing devices located in different nodes of mesh network are operable to communicate over white space channels. These computing devices include transceivers that enable communication with one another. As shown in FIG. 7, transceiver 110 is located in County 1, where channels 15 and 16 are available for white space communications. Transceiver 112 is located in County 2, where channels 16 and 22 are open. Transceiver 110 can communicate with transceiver 112 over white space channel 16, because channel 16 is available in both Counties 1 and 2. Transceiver 114 is located in County 3, and can communicate with transceiver 112 over channel 22, which is available in both Counties 2 and 3. Finally, transceiver 116 located in County 4 can communicate with transceiver 114 over channel 19. In mesh network 100, data can be communicated between any two transceivers even if the Counties those transceivers are located in share no common channels by using intermediary nodes of the mesh network. It should be recognized that any number of transceivers may be used in each jurisdiction and any number of jurisdictions may be included in the mesh network.

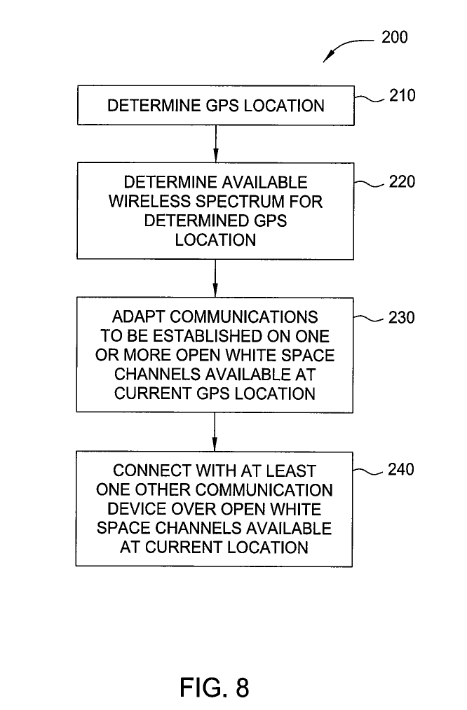

FIG. 8 is a flowchart describing one example method 200 of adapting a wireless system for use in a specific geographic location. In particular, the illustrated method can produce a system for communicating over available white space channels. The steps illustrated in FIG. 8 may be combined, modified, or deleted where appropriate. Additional steps may also be added to the example operation. Furthermore, the described steps may be performed in any suitable order.

The process begins with Step 210. In Step 210, the location of at least one device is determined using at least one GPS sensor. Multiple GPS antennas could be used in this step to improve the chances of a GPS sensor receiving a sufficiently strong signal from GPS satellites. In other embodiments, location can be determined by methods other than GPS, such as using cellular towers.

In Step 220, available wireless spectrum for the determined GPS location is determined. This step functions to associate the available portions of the wireless spectrum with the GPS location determined in Step 210. The available frequencies in the wireless spectrum can be the white space Wi-Fi specifications in the United States, or can also be international standards or local and regional wireless spectrum regulations, such as international borders, international waters, provinces or states or other regions within a country. The available wireless spectrum can be determined from a lookup table of individual GPS values and/or ranges of GPS values, a mapping software algorithm comparing the GPS location to regions outlined on a map, or a cellular data connection or 802.11 a/b/g/n Wi-Fi connection that queries a website or server with the measured GPS location. A listing of at least one white space Wi-Fi channel that can be used at the current GPS location can be received over a data connection.

Step 230 recites adapting communications to be established on one or more open white space channels available at current GPS locations. This step can adapt any wireless communication device (such as a robot controller, a robotic device, a laptop computer with a wireless radio, a mobile phone, a walkie-talkie, a wireless video camera, etc.) to communicate over an open white space channel. Step 230 can accept the outputs of a query using a GPS location to either a local algorithm, a local database, a remote database, or any other algorithm associating GPS location with allowed communication frequencies, and reconfigure the radios either as a configuration of a software defined radio, a configuration of an FPGA, or a parameter fed into an electronic circuit, (e.g. voltage, current, clock signal, clock signal frequency). In one variation, Step 230 can include a frequency hopping algorithm to hop between available frequency channels. In another variation, Step 230 can include using multiple available frequency channels to increase the available data rate. In yet another variation, Step 230 can include measuring interference on each available channel, and selecting a channel with the least interference. In still yet another variation, step 230 can include selecting an available channel with the best range of communication.

An optional step, Step 240, recites connecting with at least one other communication device over open white space channels available at the current location. This step functions to create a mesh network across two or more transceivers using white space Wi-Fi channels. For example, as shown in FIG. 7, a mesh network can be constructed across four counties (which each may have different available channels).

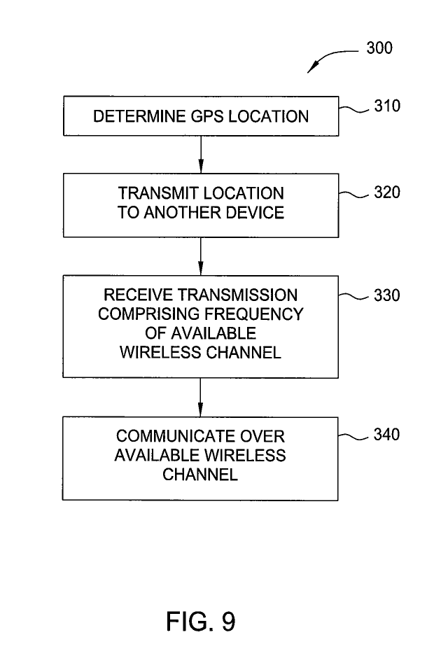

FIG. 9 is a flowchart describing another example method 300 of adapting a wireless system for use in a specific geographic location. In particular, the method illustrates the steps that can occur at a controlled device. The steps illustrated in FIG. 9 may be combined, modified, or deleted where appropriate. Additional steps may also be added to the example operation. Furthermore, the described steps may be performed in any suitable order.

The process begins with Step 310. In Step 310, the location of the controlled device is determined using at least one GPS sensor. Multiple GPS antennas could be used in this step to improve the chances of a GPS sensor receiving a sufficiently strong signal from GPS satellites. In other embodiments, location can be determined by methods other than GPS, such as cellular towers.

In Step 320, the determined GPS location is transmitted to another device. As one example, a robotic device may determine its GPS location and transmit that information to a controller of the robotic device. The controller may then use that location information to select an available wireless channel. The available channels can be the white space Wi-Fi specifications in the United States, or can also be international standards or local and regional wireless spectrum regulations. The channel can be determined from a lookup table of individual GPS values and/or ranges of GPS values, a mapping software algorithm comparing the GPS location to regions outlined on a map, or a cellular data connection or 802.11 a/b/g/n Wi-Fi connection that queries a website or server with the measured GPS location. A listing of at least one white space Wi-Fi channel that can be used at the current GPS location can be received by the controller over a data connection.

In Step 330, the controlled device receives a transmission comprising the frequency of an available wireless channel. This transmission can come from the controller, which notifies the controlled device of the selected channel on which communication will occur. The controller and the controlled device can then prepare to communicate over the available channel. The controller can select the available channel in a variety of ways as described above, and can also consider a number of variables when selecting the channel, also described above.

In Step 340, the controller and the controlled device communicate over the selected wireless channel. In one or both of the devices, the radios can be reconfigured either as a configuration of a software defined radio, a configuration of an FPGA, or a parameter fed into an electronic circuit to allow for communication over the new channel. In one variation, Step 340 can include a frequency hopping algorithm to hop between available frequency channels. In another variation, Step 340 can include using multiple available frequency channels to increase the available data rate.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a first computing device and a second computing device,
wherein the first computing device and the second computing device communicate over a wireless channel, and the wireless channel is selected by a programmed processor in one of the computing devices from a group of available wireless channels based in part on a geographic location of at least one of the computing devices.

2. The system of claim 1, wherein at least one of the computing devices is a handheld device.

3. The system of claim 1, wherein the first computing device is a robotic device and the second computing device is a controller for the robotic device.

4. The system of claim 1, wherein the first computing device includes a GPS sensor.

5. The system of claim 1, wherein the selected wireless channel is a television white space channel.

6. The system of claim 1, wherein the wireless channel is selected from a selection of available wireless channels based at least in part on the amount of interference on the channel.

7. The system of claim 1, wherein the second computing device is programmed with a frequency hopping algorithm to hop between available wireless channels selected from the list of available wireless channels.

8. The system of claim 1, wherein at least one of the first computing device and the second computing device periodically determines its geographic location and switches to an available wireless channel if either the first computing device or the second computing device has moved to a new geographic location.

9. A system, comprising:
a controlling device and a controlled device, wherein the controlled device is a mobile device, wherein the controlling device and the controlled device communicate over a wireless channel;
wherein the controlling device is operable to detect its geographic location, and is programmed to select a wireless channel for communication between the controlling device and the controlled device based at least in part on the detected geographic location.

10. The system of claim 9, wherein the controlled device is operable to detect its current geographical location, and wherein the controlling device selects a wireless channel further based in part on the detected geographic locations of both the controlled device and the controlling device.

11. The system of claim 9, wherein the wireless channel is selected from a selection of available wireless channels based at least in part on the amount of interference on the channel.

12. A system comprising a first computing device having a first transceiver communicating with a second computing device having a second transceiver through one or more intermediate transceivers, wherein:
the first transceiver is located in a first geographic location and operable to communicate over a first wireless channel with one of the intermediate transceivers; and
the second transceiver is located in a second geographic location and operable to communicate over a second wireless channel that is different from the first wireless channel with one of the intermediate transceivers,
wherein the availability of the first wireless channel is determined based on the first geographical location and a geographical location of the intermediate transceiver in communication with the first transceiver, and the second wireless channel is determined based on the second geographic location and a geographical location of the intermediate transceiver in communication with the second transceiver.

13. The system of claim 12, wherein the first and second wireless channels are television white space channels.

14. The system of claim 12, wherein the same intermediate transceiver is in communication with the first transceiver and the second transceiver.

15. The system of claim 12, wherein the intermediate transceiver in communication with the first transceiver and the intermediate transceiver in communication with the second transceiver are different, and communicate with each other over a third wireless channel that is different from the first and second wireless channels.

16. The system of claim 12, wherein the first wireless channel is selected from a selection of available wireless channels based at least in part on the amount of interference on the channel.

17. A method implemented in a controlling device for carrying out wireless communication with a controlled device, comprising:
determining a geographic location of the controlling device;
determining wireless channels that are available at the geographic location;
selecting an available wireless channel based in part on the geographical location of the controlling device; and
communicating over the selected wireless channel with the controlled device.

18. The method of claim 17, wherein the selected wireless channel is a television white space channel.

19. The method of claim 17, further comprising:
determining a geographic location of the controlled device,
wherein the available wireless channel is selected based on the geographic location of the controlling device and the geographic location of the controlled device.

20. The method of claim 17, wherein the available wireless channel is selected from a selection of available wireless channels based at least in part on the amount of interference on the channel.

21. A method implemented in a controlled device for carrying out wireless communication with a controlling device, comprising:
determining a geographic location of the controlled device;
transmitting the geographic location of the controlled device to the controlling device over a first wireless channel;
receiving a transmission from the controlling device indicating a frequency of a second wireless channel; and
communicating with the controlling device over the second wireless channel.

22. The method of claim 21, wherein the controlling device determines wireless channels available at the geographic location and selects one of the available wireless channels as the second wireless channel.

23. The method of claim 21, wherein the available wireless channel is a television white space channel.

24. The method of claim 22, wherein the available wireless channel is selected from a selection of available wireless channels based at least in part on the amount of interference on the channel.
